(19) United States
(12) Patent Application Publication
(10) Pub. No.: US 2019/0369275 A1
(43) Pub. Date: Dec. 5, 2019

(54) A METHOD, A SYSTEM AND A COMPUTER PROGRAM PRODUCT FOR TRANSMITTING SURVEY AND/OR SEISMIC DATA

(71) Applicant: Fugro N.V., Leidschendam (NL)

(72) Inventors: Stephen John FEWINGS, Glasgow (GB); Paul KENNEDY, Perth (AU)

(73) Assignee: Fugro N.V., Leidschendam (NL)

(21) Appl. No.: 16/325,839

(22) PCT Filed: Aug. 15, 2017
(86) PCT No.: PCT/NL2017/050535

§ 371 Date: Feb. 15, 2019

(30) Foreign Application Priority Data
Aug. 15, 2016 (NL) 2017315

(51) Int. Cl. G01V 1/22; G01V 1/38; G01S 15/89; H04B 1/66; H04L 29/08

(52) U.S. Cl. CPC G01V 1/22; G01V 1/3808; H04L 67/12; H04B 1/66; G01S 15/8902

(57) ABSTRACT

The invention relates to a method for transmitting survey and/or seismic data from an offshore site to a remotely located site. The method comprises the step of filtering survey and/or seismic data obtained at the offshore site. Further, the method comprises a step of transmitting the compressed survey and/or seismic data via a data transfer channel towards a remotely located server.

The invention relates to a method for transmitting survey and/or seismic data from an offshore site to an remotely located site.

Survey and seismic operations in an area to be explored are performed in the following manner. First, a plan is made where a survey or exploration of seismic data is to be performed and by which subcontractor. Then, the subcontractor performs the survey or seismic acquisition at a remote location, e.g. offshore, and provides the requested data to the client. In order to interpret the data that is collected by the subcontractor, the client may need to correlate such data with confidential internal data relating, for example survey data, previous company in-field assets, reservoir maps. Then, the client analyses the data together with his internal (proprietary) data and performs operations and/or decisions in view of the new updated data.

Usually, subcontractors do not have access to the client's internal data and are therefore not in a position to make decision changes in view of the data being acquired in a survey or seismic data project that is acquired, for example, offshore. The post-processing and analysis of the data acquired during a surveying or exploration mission is limited to quality assurance since in order to perform a more in-depth analysis that could lead to decisions such as, e.g., changing the area to be analysed or, in more general terms, changes on the initial plan, the subcontractor would need to correlate the data being acquired with the client's internal data.

Therefore, in case the data acquired for some reason is not useful for operations such as poorly formatted, poorly collected or at an incorrect location, most of the data acquisition time is lost and a new plan has to be made onshore for the vessel to return to the relevant area offshore. This is also particularly relevant when, in a survey operation, more detailed data are needed in a particular area. Then, the vessel has to return to shore for the analysis of the data by the client, and, after that data is processed and reviewed, a new plan has to be made for the vessel to return to the relevant area to take more detailed data of the relevant area. Considering that, in some cases, to get to the relevant areas it may take up to seven or more sailing days, this new taking of data increases substantially survey operational costs.

It is an object of the invention to provide a method for transmitting survey and/or seismic data that enables a reduction of a need to return to the area to be explored for further survey or seismic activities. Thereto, according to an aspect of the invention, a method for transmitting survey and/or seismic data from an offshore site to a remotely located site is provided, comprising the steps of filtering survey and/or seismic data obtained at the offshore site, and transmitting the filtered survey and/or seismic data via a wireless data transfer channel towards a remotely located server.

By filtering survey and/or seismic data obtained at the offshore site, huge data files can be reduced considerably thus enabling an efficient and effective transmission of relevant information to the remotely located server. By transferring, at least part of the information from the offshore site to the remote location, at the client, the client can monitor the data being acquired in operations and detect clear locations wherein no further data acquisition is required and/or areas wherein more details are needed, thereby having the opportunity to correct the initial plan before the vessel returns to shore. This methodology allows for costs saving and more efficient data acquisition operations. In this respect it is noted that satellite communication offshore tends to be slow and expensive. Therefore, the filtering step significantly contributes in the obtained reduction of a need that the vessel has to return to the area to be explored for further survey or seismic activities.

The remotely located server is e.g. located onshore or at another location remote from the offshore site, e.g. on a platform at sea.

Preferably, the unfiltered survey and/or seismic data is transmitted towards the remotely located server, after a memory device containing the unfiltered survey and/or seismic data physically has moved to a site having regular internet connectivity with the remotely located server. Then, the filtered survey and/or seismic data, at the remotely located server, can be completed using the transmitted unfiltered survey and/or seismic data.

Advantageously, the filtering step may include a step of compressing survey and/or seismic data, e.g. using so-called off-the-shelf solutions and/or other compression algorithms. Preferably, depending on a type of data to be compressed, a pre-determined compression algorithm is applied. The compression algorithm may be lossy for a first class of data types while the compression algorithm may be lossless for a second class of data types.

The invention also relates to a system.

Further, the invention relates to a computer program product. A computer program product may comprise a set of computer executable instructions stored on a data carrier, such as a flash memory, a CD, a DVD or a cloud storage. The set of computer executable instructions, which allow a programmable computer to carry out the method as defined above, may also be available for downloading from a remote server, for example via the Internet. The computer program can be executed at least partially on the offshore site, on the remote location and/or in an accessible cloud location.

Other advantageous options and embodiments according to the invention are described in the following claims.

By way of example only, embodiments of the present invention will now be described with reference to the accompanying figures in which

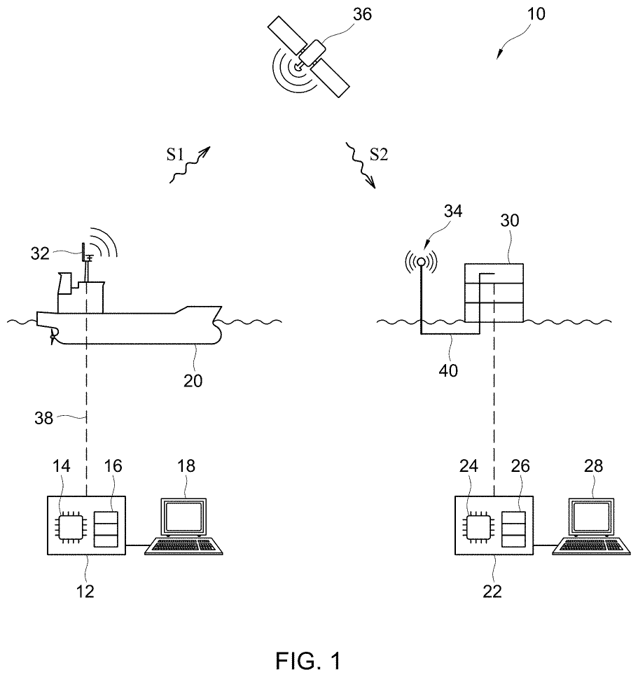

FIG. 1 shows a schematic view of a system according to the invention;

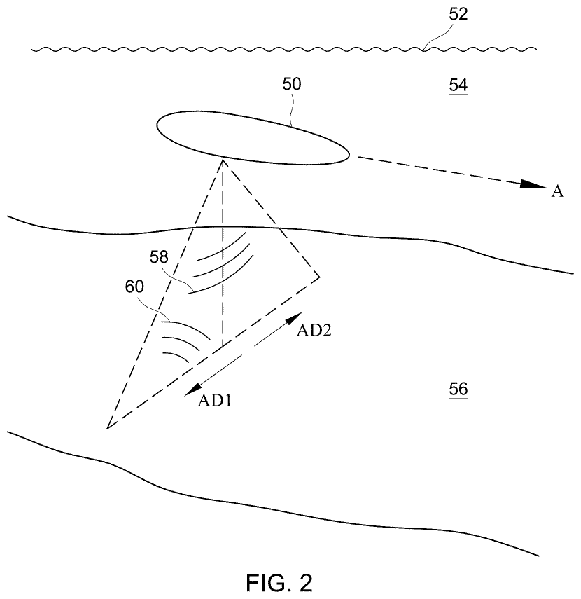

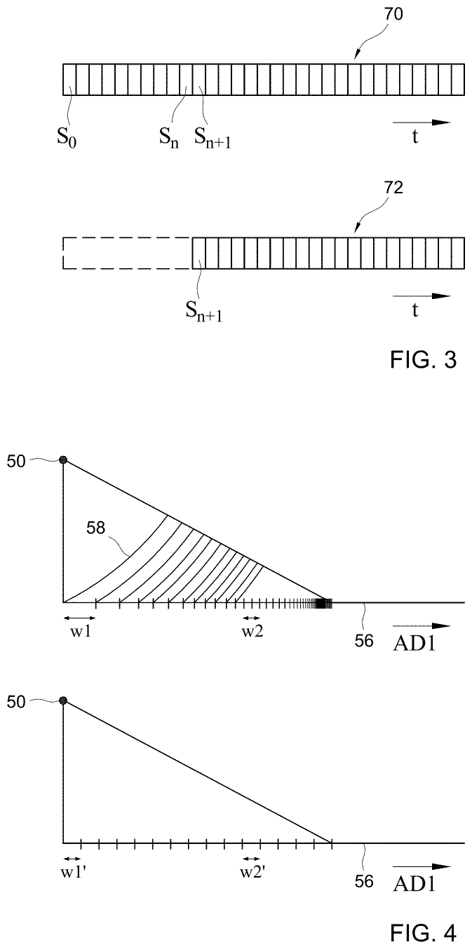

FIG. 2 shows a perspective schematic view of a sidescan sonar device; FIG. 3 shows a diagram of two across-track channel records;

FIG. 4 shows a diagram depicting two cross sectional views of the device;

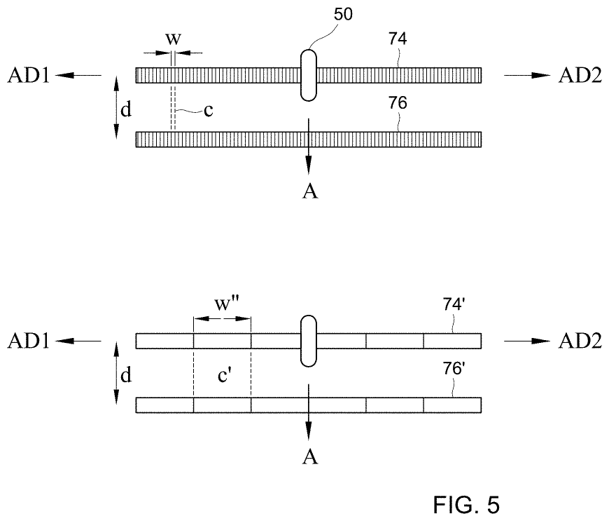

FIG. 5 shows a diagram depicting two top views of the device and sample records;

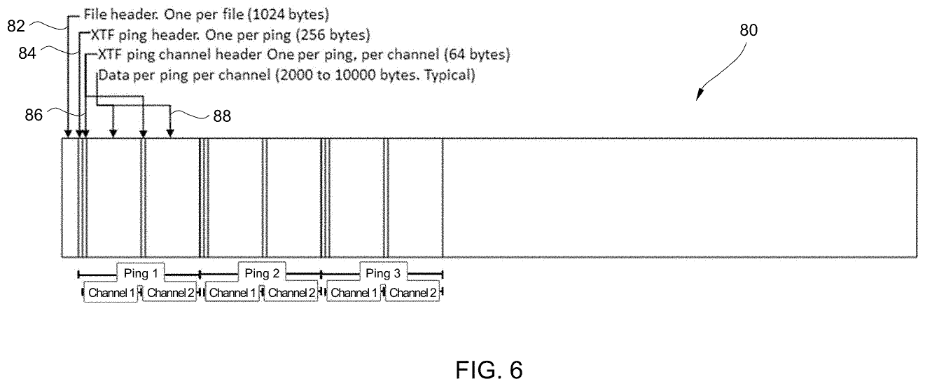

FIG. 6 shows a diagram of an XTF file format;

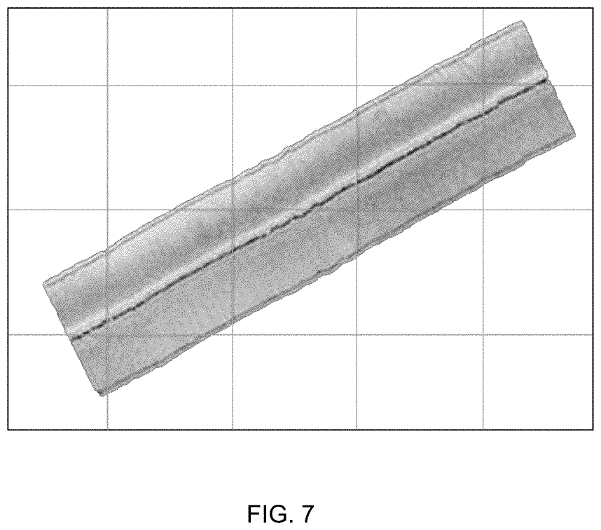

FIG. 7 shows a visual representation of an XTF file;

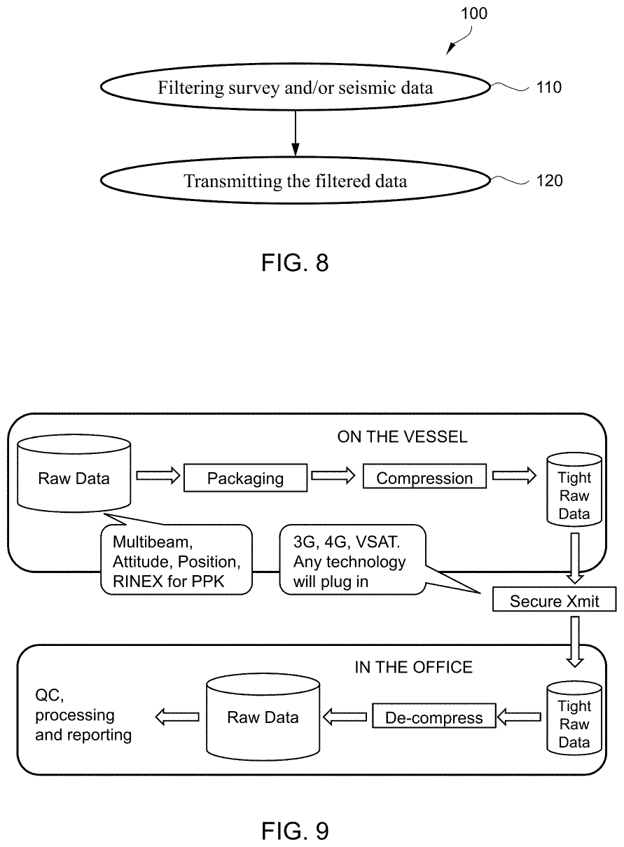

FIG. 8 shows a flow chart of an embodiment of a method according to the invention, and

FIG. 9 shows a flow chart of a further embodiment of a method according to the invention.

The figures merely illustrate preferred embodiments according to the invention. In the figures, the same reference numbers refer to equal or corresponding parts.

FIG. 1 shows a schematic view of a system 10 according to the invention. The system 10 is configured for transmitting survey and/or seismic data, and comprises a server 12 that is based on an offshore site. In the shown embodiment the offshore site is an exploration vessel 20 of a subcontractor performing survey or seismic acquisition activities. The server 12 is provided with a processor 14 and a memory 16 containing survey and/or seismic data that has been obtained at the vessel 20 using acquisition devices and techniques. In the shown embodiment the server 12 is further provided with an I/O module 18 having a display and a keyboard. Apparently, the I/O module 18 may be implemented in another way, e.g. including a touchscreen.

The system additionally comprises another server 22 located on a location remote from the server 12 on the offshore site, for example on an onshore site. In the shown embodiment the remote location is a laboratory or office 30 of a client. Similar to the offshore based server 12, also the remotely located server 22 includes a processor 24, a memory 26 and an I/O module 28.

Further, the system is arranged for transmitting data from the offshore based server 12 to the remotely located server 22, via a wireless data transfer channel, e.g. a satellite connection, a cell phone network or any other Internet service provision hardware. In the shown embodiment, the wireless data transfer channel is based on mobile internet technology and is realized between an offshore antenna 32 on the vessel 20 connected to the offshore based server 12, and a remote antenna 34 onshore connected via Internet 40 to the laboratory or office 30. A satellite system 36 is configured to receive and transmit communication signals, respectively. In the shown embodiment, the data transfer channel between the offshore based server 12 and the remotely located, here onshore based server 22 is formed by an offshore data connection 38 between the offshore based server 12 and the vessel based antenna 32, a first wireless data connection between the vessel based antenna 32 and the satellite system 36, a second wireless data connection between the satellite system 36 and the onshore based antenna 34, and an Internet data connection 40 between the onshore based antenna 34 and the onshore based server 22. Here, first wireless signals 51 are transmitted via the first wireless data connection, while second wireless signals S2 are transmitted via the second wireless data connection, the first and second wireless data connection forming the wireless data transfer channel.

Generally, the vessel is provided with exploration devices for performing survey activities, e.g. for the search of objects in the subsea such as remote infrastructure network including subsea pipelines, subsea cables, oil and gas infield assets and other offshore seabed located objects, wrecked ships or planes, performing seismic exploration techniques, map the seabed topology, amongst other geophysical activities.

According to an aspect of the invention, the offshore based server 12 is configured for filtering the survey and/or seismic data and for transmitting the filtered survey and/or seismic data towards the remotely located server 22. In the filtering step, data, preferably less relevant data or superfluous data, is removed. The data received at the remotely located server 22 can subsequently be processed, e.g. by a decompressing step and an analysing step. By performing, at the offshore based server 12, the filtering and transmitting step, a service can be offered of moving data files from a vessel to an office onshore using minimal bandwidth and maximum reliability. It may provide management for automatic packaging, compression and data transfer followed by decompression and unpackaging in the onshore based server 22.

The data files received at the remotely located server 22 do not necessarily contain exactly the same data as those selected for transmission, either because data was intentionally removed to reduce the data volume, or it was unavoidably removed due to incompatibility with intermediate file formats such as GSF. The filtered data can be transmitted to land based processing centres for quality control checks in aiding timely decision making, i.e. re-acquire the survey data if quality is in-adequate.

Some data can intentionally be compressed with lossy compression so that the resultant data files are smaller, but have less precision or resolution. In some cases this lossy compression is explicit, and the degree chosen during configuration, e.g. XtfCompress configuration includes options for reducing resolution. In other cases loss of precision is an unavoidable consequence of conversion between data formats, e.g. subsea depth data in pos files may have a precision of 1 mm, but GSF files limit such data to a resolution of 1 cm.

Some data can be removed completely from the input files. This may be configurable, e.g. removal of water column data with XtfCompress, or removal of dx, dy by pos2gsf. Other data can be removed automatically and silently, e.g. not all pos fields are supported by GSF, so pos2gsf necessarily does not pass them through. Some data may be transferred, but sampled at a different rate. E.g. when gsf2pos creates a gpsPositionAbsolute file, there is one record per ping, independently of the frequency of the records in the position file provided to pos2gsf. Some data may be transferred in a different form. E.g., gsf2pos always outputs position as a GpsPositionAbsolute file, even when the input to pos2gsf was a position.pos file.

According to an aspect of the invention a method is provided for compressing acquired datasets and enabling efficient transmission via wireless data transmission channels, e.g. using standard mobile telephony. The method generates opportunities to ensure that accuracy and reliability of the data is not compromised, optionally including selecting optimum data file formats for upload via mobile internet devices, using optimum file sizes for fast and efficient upload and download via Internet, and integration of the method with existing cellular systems and/or existing bandwidth of data transfer.

Preferably, the filtering step includes compressing survey and/or seismic data so that less data has to be transmitted via the wireless data transfer channel. In a compressing step, the file size of data is reduced to a compressed format. After receipt at the remotely located server, compressed data can be uncompressed for further processing. More preferably, a lossy and/or a lossless compression technique can be used for compressing survey and/or seismic data.

Advantageously, the filtering step may further include a step of selecting data having a minimal redundancy. Then, redundant information can be removed, thus increasing the information density of the transmitted data.

Further, the filtering step may include selecting a minimum amount of raw data that is needed to process mosaic grid charts at the remotely located server 22. As a result, the remotely located server 22 is provided with enough information to perform a meaningful analysis including the client's internal data, while a minimum transmission effort has to be performed.

As an example, the filtering step may include a step of reducing the spatial resolution of the survey and/or seismic data. In practice, the number of across-track samples can be reduced to match a spacing of the along track samples. As an example, sidescan sonar samples at high resolution across track, i.e. in a direction perpendicular to the travel direction of the boat, than along-track, i.e. along the motion direction of the boat. Because an across-track resolution is higher than needed to create square gridded data, i.e. mosaics, many across track samples can be removed from the acquired data without loosing meaningful information. Here, the data size can be reduced up to a factor of circa six.

Further, water column data samples can be removed since they generally do not contribute for final mosaicking. Water column samples are usually recorded to XTF files. These are not required for mosaicking and can thus be removed before transmission without loosing meaningful information.

In a specific example, files, file types and folders that need to be transferred to the remotely located server 22 are selected. Further, custom compression tools can be configured for optimizing band-width usage and quality of transmitted data files. Compressed data can then be packaged and transmitted to the remotely located server 22 for unpackaging, decompressing and analysing. Advantageously, it is checked whether new data or an update of data is to be transmitted to the remotely located server 22, either manually or automatically.

Data can be compressed using open standard compression techniques, e.g. in a 7-Zip format, or newly developed compression techniques. The 7-Zip algorithm is a lossless compression tool. Alternatively, Windows Zip produces files that can be decompressed by Windows without the need for any third-party software. Advantageously, the system 10 can be arranged such that specific compression tools can be selected and/or new compression tools can be added easily, for the purpose of packaging the survey and/or seismic data obtained at the offshore site.

Compression tools may relate to different techniques, including the following:

1. XTF compression. Here, the data file size is reduced based on custom lossy compression techniques so that a minimum amount of raw data can be sent to the onshore based server 22 to perform and complete a processing task of mosaic grid charts as required by a client. XTF compression is lossy meaning that uncompressed data, at the onshore based server 22 is not identical to the original data. Optionally, a water column can be removed from slant range and/or a slant range can be converted to ground range, e.g. if the altitude is 15% of the slant range, slant-range correction reduces the data size by about 1%. In fact if the XTF file includes a time delay to start of recording, slant range correction may increase the amount of data. E.g. given SlantRange=100, Altitude=15, if time delay removes 10 m of the water column, the resultant file will be circa 10% smaller. Generally, said increase is more than compensated for by reducing across-track resolution.

As indicated above, reducing the across-track resolution gives the best compression if across-track resolution is significantly higher than along-track. This will lose across-track resolution. It may work best with ground range data which may be converted from slant range. On the other hand, if slant range data is used there may be significant loss of quality around nadir. Output intensity values may be calculated as either the average or the maximum value of the corresponding input values.

XTF is a standard file format used to contain data acquired from a sidescan sonar device. The configuration of the data acquisition might log as much of the available raw data as possible. The processing of sidescan sonar data does not always require all the logged data. By understanding the form of the raw logged data and the requirements of the processing calculations a large amount of the logged raw data may be removed from the files without materially impacting the quality of the deliverables.

FIG. 2 shows a perspective schematic view of a sidescan sonar device 50 moving in the sea 54 between the sea surface 52 and the seabed 56. The sidescan sonar device 50 transmits a “ping” of sound 58 into the water 54 and then records for a period after the ping. The recording is the reflection 60 of the source sound as it bounces off the seabed 56 and features below. The sound is directed into the water 54 such that it is focused to the right and left of the device 50, i.e. in a first across direction AD1 along the seabed 56, transverse to a moving direction A of the device 50, also called along-track motion direction, and in a second across direction AD2 along the seabaed 56, opposite to the first across direction AD1, also transverse to the moving direction A of the device 50. The reflection 60 from each side is recorded as a separate channel, i.e. reflection from the right side, in the first across direction AD1 is received as a first across-track channel and reflection from the left side, in the second across direction AD2 is received as a second across-track channel.

Because the sound travels through water at a known speed, the recorded samples in the first and second across-track channels represent the reflection 60 from the seabed 56 at increasing distance from the device 50. The intensity of each sample represents the acoustic reflectivity of the seabed 56 at a known distance from the device 50. The sidescan sonar device 50 pings at regular intervals as it is moves through the water 54. Thus it collects a series of pings along-track.

The sample rate of the reflected sound might be in the order of 20 kHz. Each intensity sample in the first and second across-track channels represents an across-track width of the seabed 56 of a few centimetres at most. The time interval between individual pings must be large enough such that preferably all the possible reflections from the last ping have returned before the next ping is transmitted. This distance along-track that is travelled between individual pings may depend on the height of the device 50 above the seabed 56 and the speed of the device 50. It depends on a number of factors but can be selected to be circa several decimeters up to circa a meter. However, the distance along-track that is travelled between individual pings might be more than circa 1 meter or less than circa 1 decimeter.

An XTFCompress routine may use at least one of the three different approaches explained below to reduce the amount of data stored in an XTF file. According to a first approach data related to a water column can be removed from slant-range data. Usually, a process of recording reflection intensities usually starts immediately after transmitting the ping 58. As a first reflected sound 60 will not be received until it has bounced off the closest seabed area below the device 50, the initial part of the recording contains no intensity values. This part of the data is called the water column data. FIG. 3 shows a diagram of two across-track channel records. The upper across-track channel record 70 contains samples s₀, . . . , s₀, . . . , sₙ, sₙ₊₁, . . . the subscript n representing the sample number as a function of time t. The sample so represents a reflection value at the moment of transmitting the ping. Then, no reflection 60 has arrived. The sample so is zero. At some moment, the first reflection 60 arrives resulting in a reflection sample sₙ₊₁ deviating from zero. All samples s₀, . . . , sₙ prior to said first reflection sample sₙ₊₁ are zero as no reflection has yet arrived. Operators record the complete across-track channel record 70 containing all samples s₀, . . . , sₙ, sₙ₊₁, . . . as they are interested in the time of first return (reflection) so they may calculate how deep the seabed 56 is below the device 50, similar to the principle how an echo-sounder on a boat works. However, for processing, the water column intensity samples s₀, . . . , sₙ are not required. XTFCompress may remove these samples s₀, . . . , sₙ from the file or record and rather stores the samples starting from the sample sₙ₊₁ containing the first reflection, i.e. when the seabed reflection was first seen, as shown in the lower, updated across-track channel record 72. If the device 50 is located many meters above the seabed 58 the removal of samples s₀, . . . , sₙ prior to said first reflection sample sₙ₊₁ can save significant data space in an updated xtf file. The XTF file format has a provision for storing the time period between transmission of the ping 58 and the first recorded sample number, sₙ₊₁. According to a second approach slant-range data is converted into ground range data. The intensity samples are generally collected at a fixed time sampling interval. FIG. 4 shows a diagram depicting two cross sectional views of the device, transverse to the along track direction A. The upper cross sectional view schematically shows the propagation of a ping 58 from the device 50 towards the seabed 56 as a function of the first across-track direction AD1. Because the samples are reflected from a seabed 56 that extends in the first across-track direction AD1, the across-track width w of seabed section generating the sample data varies as a triangular function of the distance from the device 50. As an example, samples generated from immediately below the device 50 may be generated by a first across-track width w1 of circa 20 cm in the first across-track direction AD1 on the seabed 56 while samples generated by a seabed section that is remote in the first across-track direction, e.g. at 50 metres from below the device 50, may represent a seabed section having a second across-track width w2 of circa 3 cm. There are many more samples per processed map square in the outer regions than there are in the inner regions. XTFCompress may create a map of the seabed intensities that is more evenly distributed in the across-track directions AD1, AD2. By resampling the updated reflection sample data may represent a more uniform width distribution of individual width sections w1′, w2′ generating the updated sample data. The lower cross section view in FIG. 4 schematically shows the width sections w1′, w2′ in the first across-track direction AD1. The updated sample data are referred to as so-called seabed ground-range data, the original sample data are referred to as so-called seabed slant-range data. In the ground-range data the samples are evenly distributed across the seabed rather than evenly distributed in a time period of the samples. By resampling, the data are converted and the total file size can be reduced. The XTF file format has a provision to store sample data of both range types, i.e. as slant-range data and ground-range data. According to a third approach the resolution of across-track samples is reduced. FIG. 5 shows a diagram depicting two top views of the device 50 and sample records. In the upper top view, the device 50 is shown moving in the along-track direction A while collecting samples in the across-track directions AD1, AD2. In the top view a first and a second, subsequent across-track record 74, 76 are shown resulting from the transmission of two subsequent pings. The across-track sampling of the seabed 56 has a much higher resolution than the along-track sampling resolution, i.e. the dimension of a sample cell C in the along-track direction, also called length d, is substantially larger than a dimension of a sample cell C, i.e. its width w, in the across-track direction AD1, AD2. As an example, the cell width w can be a few centimetres while the cell length d can be sub-metre. In order to process the samples in a grid having equal length and width, the sample data can advantageously be reduced without reducing the resolution in a final processed intensity grid file. XTFCompress may calculate the along-track resolution depending on the transmission frequency of the pings and the velocity of the device 50. Further, XTFCompress may resample the across-track samples to match the cell width w to a certain degree with the cell length d in the grid, e.g. by rendering the cell width w equal to the cell length d. In the lower top view of FIG. 5 a representation of the resampled data is shown having grid cells C′ with equal or substantially equal length d and width w″. The aggregate across-track sample may be an average or maximum of the sub-samples. An average allows individual samples to be considered and so represent all the seabed. The maximum sample intensity allows a single highly reflective object to be represented. The choice of sampling may depend on the final processing requirements, e.g. for generating a seabed map or for identifying specific man-made “contacts”. In practice, the XTF compress filtering step may include the following:

1. Aggregate across track samples to match along track resolution;
2. Slant-range correction—removing the water column samples;
3. Histogram development of all samples and conversion from 2 bytes per sample to 1 byte per sample; and
4. Compression of resultant XTF dataset.

For testing purposes, a sidescan-sonar dataset was created in XTF format. This file stores file header, ping header, ping channel header and channel data. Each of these sections has unused or redundant fields that will be identified and removed through the newly developed data compression systems. Table 1 summarises the information typically stored in a XTF dataset:

TABLE 1
XTF Files

| Section | Structure | Size | Notes |
|---|---|---|---|
| File | XTFFILEHEADER | 1024 | Global file settings |
| header | | | such as recording |
| | | | program, file data |
| | | | channels, text notes, |
| | | | channel information |
| Ping | XTFPINGHEADER | 256 | Ping times, sensor |
| Header | | | values, positions |
| Ping | XTFPINGCHANHEADER | number of | Gains, data range, |
| Channel | | channels* 64 | sample frequency, |
| Header | | | contact details |
| Channel | | 1 or 2 bytes | Typically 3000 to |
| data | | per sample | 5000 samples per |
| | | | channel |

Table 2 summarises the test file metrics in comparison to a typical file:

TABLE 2
Sample XTF File vs XTF Typical File

| | | | | Ping | | |
|---|---|---|---|---|---|---|
| | | | Sample | rate | | |
| | Samples | Channels | size | (Hz) | Bytes/sec | Mbit/sec |
| Typical | 3000 | 2 | 2 | 5 | 60000 | 0.48 |
| data file | | | | | | |
| Test file | 3631 | 2 | 2 | 5 | 72000 | 0.58 |

The following information in Table 3 governs the sample data file for testing:

TABLE 3
Sample XTF File Metrics

| File recording length | 10 | minutes |
|---|---|---|
| Sample frequency | 22 | kHz |
| Ping rate | 5.6 | Hz |
| File data size | 48 MB (48989452 bytes) | |
| File data rate | 0.58 | Mbits/sec |

| | |
|---|---|
| Desired file size (rate) | 9.3 MB (0.125 Mbits/sec) |

Further, FIG. 6 shows a diagram of an XTF file format 80, including a file header 82, an XTF ping header 84, an XTF ping channel header 86, one per ping, per channel, and reflection sample data 88.

FIG. 7 provides a visual representation of the XTF file.

In view of the tests, the following is noted:

1. Aggregate across track samples to match the along track resolution. At 1092 metres along and each channel 130 metres wide, the 3373 pings and 3631 samples gave a 32 cm along-track and 3.6 cm across track resolution. When the mosaic is gridded at 1 metre resolution, the across-track sampling resolution contains a lot of redundant samples. The across-track sampling could therefore be reduced by a factor of 6. This equates to an approximate 80% reduction in size.
2. Slant Range correct—removing the water column samples:
Operational procedures recommend including the water column data in the samples so that bottom tracking can be reworked after acquisition. These water column samples are not used for final mosaicing and can be removed for compression purposes. The tow fish (scanner) is generally 10% to 20% of the total across-track range above the seabed. i.e. for 130 m range, it is approximately 15 m above the seabed. The XTF format supports Slant Range Corrected data where ping samples are corrected to represent equal distances on the seabed rather than samples representing equal periods of time. This compression would involve Slat Range correcting the XTF data. An approximate 15% reduction in file size was achieved as a result of this.
3. Histogram development of all samples and conversion from 2 bytes per sample to 1 byte per sample:
Side scan sonar data samples are always recorded using 2 bytes per sample. This provides 65535 possible intensity values per sample. Experience with Geocoder shows that seabed sound intensity values may be histogrammed to 256 value range and there is little or no loss of mosaic quality. This would allow conversion of 2 byte samples to single byte samples. An approximate 50% reduction in file size was achieved as a result of this.
4. Compression of resultant XTF dataset:
Lossless data compression routines such as those used to zip data files is not particularly effective on XTF datasets. Two compression libraries were tried on the sample dataset with the following compression ratios. An approximate 17% reduction in file size was achieved as a result of this activity (as shown in Table 4).

TABLE 4
Compression results

| | |
|---|---|
| Original file size | 50,083,328 |
| Standard WinZip Compressed file size | 41,347,459 |
| Standard WinZip compression ratio | 17% |
| 7Zip compressed file size (zipx format) | 36,603,541 |
| 7Zip compression ratio (zipx format) | 27% |

There are a range of data redundancies in logged XTF datasets that, in theory, allow considerable compression. Assuming 0.58 Mbit/sec for the original file, after applying all the compression techniques above the data may be reduced to approximately 0.045 Mbits/second which is well under the 0.125 Mbits/second of the current compression technologies. For the example file used, this would compress from 48 MB down to 1.72 MB.

Apart from XTF compression described above, compression tools may relate to further techniques, including the following:

2. All file datagram filter. All files can be the logged data obtained via exploration techniques. The logged file may contain many data streams from a multibeam device. For a typical seabed survey many of these datastreams are not required. For example, the seabed intensity, raw range and angles, multiple position sensor feeds may all be inside the logged All file but are not required for the primary survey deliverable. The filter tools allow removal of unnecessary data packets from the file, thereby optionally reducing the data size in a range from circa 20% to circa 80%. Here, the compression is lossless i.e. the data samples values are not changed so that the uncompressed data, at the remotely located server 22, are in principle identical to the original data.
3. SegYSize reduction. SegY is a standard file format that can be used to store seismic data. A compression tool has been realized reducing the size of these files potentially up to circa 60%. The conversion is lossy. The compression method is aimed at reducing the sample values from 16 bit to 8 bit thus removing circa a half of the data. This format can be used to store single-line seismic reflection digital data on magnetic tapes.
4. JSF compression. JSF is a file format of data acquired by specific seismic and side-scan sonar devices. A compression technique can be implemented wherein an appropriate level of compression can be selected. Generally, higher levels create smaller files for transmission, but are more lossy.
5. Lowering sample rates. A data file format developed by Fugro can be used to store logged survey data. GSF is an open source industry file format used to store the same. Generally, data is sampled at much higher rates and much higher precision than is required for most processing. The GSF format stores less precision and lower sample rates. Consequently, upon converting files into the GSF format the file size is much smaller. The compression is lossy and may result in a compression ranging from circa 50% to circa 80%. Further, position files that contain grid coordinates but not geographical coordinates can be filtered out. Also, ping and attitude frequency can be entered to filter out large amounts of data. As an example, if data has been acquired at 10 Hz then, the data can be reduced by half by selecting a sampling rate of 5 Hz, thus also reducing the data spatial resolution.

FIG. 8 shows a flow chart of an embodiment of a method 100 according to the invention. The method 100 is used for transmitting survey and/or seismic data from an offshore site to an remotely located site, and comprises a step of filtering 110 survey and/or seismic data obtained at the offshore site, and a step of transmitting 120 the filtered survey and/or seismic data via a data transfer channel towards a remotely located server.

The method of transmitting survey and/or seismic data can be facilitated using dedicated hardware structures, such as computer servers, e.g. a cloud-based server. Otherwise, the method can also at least partially be performed using a computer program product comprising instructions for causing a processor of a computer system to perform monitoring of the activities. All (sub)steps can in principle be performed on a single or a multiple number of processors, located at the offshore site, the remotely located site and/or the cloud. A processor can be loaded with a specific software module, e.g. for performing a specific step or sub step of the method. Dedicated software modules can be provided, e.g. from the Internet.

FIG. 9 shows a flow chart of further embodiment of a method 100 according to the invention. In practice, the method may include a step of acquiring raw data offshore. Then, data files can be selected, either manually and/or automatically. Subsequently, selected data files can be filtered in a packaging step, e.g. using custom tools such as AllfileDatagramFilter, pos2gsf and/or b2n2LAZ. Further, the method may include a compression step, e.g. custom built such as XTFCompress and/or SegYSizeReduction and/or industry standard tools such as Zip or 7Zip, thereby obtaining Tight Raw Data. Next, the compressed data is sent from the offshore site to a remotely located site, e.g. by uploading the compressed data from the offshore site and by downloading the uploaded data to the remotely located site, e.g. onshore. Preferably, the transmission is performed using a secure transmission channel, optionally encrypting the data. After receipt at the remotely located site, the transmitted data is decompressed, e.g. using the corresponding industry standard tools such as Zip and 7Zip, and unpackaged using gsf2pos, LAZ2b2n. Subsequently, the decompressed and unpackaged data can be used for further processing.

The invention is not restricted to the embodiments described herein. It will be understood that many variants are possible.

The offshore site can be vessel or another mobile platform such as an airplane. Similarly, the remotely located site can be laboratory or office or another server platform, preferably stationary, having direct access to client specific internal data files.

In principle, the data transfer channel can be implemented in another wireless technology such as point-to-point microwave transmission between Earth surface based antennas. Further, the data transfer channel can at least partly be implemented using wired transmission technology such as copper cables.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A method for transmitting survey and/or seismic data from an offshore site to a remotely located site, the method comprising:
filtering survey and/or seismic data obtained at the offshore site, and
transmitting the filtered survey and/or seismic data via a data transfer channel towards a remotely located server.

2. The method according to claim 1, further comprising:
transmitting unfiltered survey and/or seismic data towards the remotely located server, after a memory device containing the unfiltered survey and/or seismic data physically has moved to a site having regular internet connectivity with the remotely located server; and
completing the filtered survey and/or seismic data, at the remotely located server, using the transmitted unfiltered survey and/or seismic data.

3. The method according to claim 1, wherein the filtering further comprising compressing survey and/or seismic data.

4. The method according to claim 3, wherein the compressing further comprising a lossy compression technique.

5. The method according to claim 1, wherein the filtering further comprising selecting data having a minimal redundancy.

6. The method according to claim 1, wherein the filtering further comprising selecting a minimum amount of raw data that is needed to process mosaic grid charts at the remotely located server.

7. The method according to claim 1, wherein the filtering further comprising reducing the spatial resolution of the survey and/or seismic data.

8. The method according to claim 1, wherein the filtering further comprising reducing the number of across-track samples to match a spacing of along track samples.

9. The method according to claim 1, wherein the filtering further comprising removing water column data samples.

10. A system for transmitting survey and/or seismic data from an offshore site to a remotely located site, the system comprising:
at least one processor; and
a memory storing instructions, which when executed by the at least one processor causes the at least one processor to:
filter survey and/or seismic data; and
transmit, via a data transfer channel, data from the at least one processor to server at the remotely located site.

11. The system according to claim 10, wherein the data transfer channel is wireless.

12. At least one non-transitory computer readable medium storing instructions, which when executed by at least one processor, causes the at least one processor to:
filter survey and/or seismic data obtained at the offshore site, and
transmit the filtered survey and/or seismic data via a data transfer channel towards the remotely located server.
